(19) United States
(12) Patent Application Publication
(10) Pub. No.: US 2021/0089534 A1
(43) Pub. Date: Mar. 25, 2021

(54) SYSTEM AND METHOD FOR DYNAMICALLY REALLOCATING RESOURCES AMONG MULTIPLE TASK GROUPS IN A DATABASE SYSTEM

(71) Applicant: Teradata US, Inc., San Jose, CA (US)

(72) Inventors: Venu Gopal Joshi, El Segundo, CA (US); Douglas P. Brown, Rancho Santa Fe, CA (US)

(73) Assignee: Teradata US, Inc., San Diego, CA (US)

(21) Appl. No.: 16/999,254

(22) Filed: Aug. 21, 2020

Related U.S. Application Data
(60) Provisional application No. 62/902,808, filed on Sep. 19, 2019.

(51) Int. Cl. G06F 16/2453; G06F 9/48; G06F 11/34; G06F 16/21

(52) U.S. Cl. CPC G06F 16/24542; G06F 16/24549; G06F 11/3419; G06F 11/3433; G06F 16/217; G06F 9/4881

(57) ABSTRACT

A computer running a database system receives one or more queries, each query comprised of parallel threads of execution working towards the common goal of completing a user request. These threads are grouped into a schedulable object called a task group. The task groups are placed within a specific multiple tier hierarchy, and database system resources and service level goals (SLGs) allocated to the task groups according to their placement within the hierarchy. The execution of requests/tasks is monitored, and resource allocations temporarily increased to critical requests that are unlikely to meet execution goals (SLGs).

### CROSS REFERENCE TO RELATED APPLICATIONS

This application claims priority under 35 U.S.C. § 119(e) to the following co-pending and commonly assigned patent application, which is incorporated herein by reference:

Provisional Patent Application Ser. No. 62/902,808, entitled “MECHANISM FOR DYNAMIC BOOSTING OF QUERIES IN-FLIGHT TO ACHIEVE SERVICE LEVEL GOALS IN A HIGHLY CONCURRENT DATABASE SYSTEM,” filed on Sep. 19, 2019, by Venu Gopal Joshi and Douglas P. Brown.

This application is related to the following U.S. patents, which are herein incorporated by reference in their entirety: U.S. Pat. No. 9,298,506, entitled “ASSIGNING RESOURCES AMONG MULTIPLE TASK GROUPS IN A DATABASE SYSTEM,” by Sorana Rabinovici and Venu Gopal Joshi, issued on Mar. 29, 2016; and U.S. Pat. No. 8,612,989, entitled “ASSIGNING RESOURCES AMONG MULTIPLE GROUPS OF WORKLOADS IN A DATABASE SYSTEM,” by Anita Richards and Douglas P. Brown, issued on Dec. 17, 2013.

### FIELD OF THE INVENTION

The invention relates generally to the field of database applications, and more specifically to a database system priority scheduler which organizes database threads into task groups within a specific hierarchy, assigns database system resources to task groups according to the hierarchy, and dynamically reallocates resources to critical requests that are unlikely to meet execution goals.

### BACKGROUND OF THE INVENTION

A Database Management System (“DBMS”) runs on a computer system that may include one or more computers. The computer system has resources, such as the central processing unit (“CPU”), memory, storage, input/output (“I/O”), etc., that are shared between the DBMS and other programs or systems that are running on the computer system. The DBMS itself may have resources that may be shared among different DBMS tasks that are executing at the same time. The assignment of resources among DBMS tasks is sometimes based on prioritizing tasks, with higher priority tasks being more likely, at any given time, to be assigned a greater share of the DBMS and computer system resources.

Operating systems, such as Linux, typically come with a built-in “scheduler” which is responsible for deciding which tasks run on which CPU and when. Teradata Database Systems include a “Priority Scheduler” built on top of the operating system scheduler to manage tasks and other activities that run in or support the database work.

However, database systems frequently encounter workloads that inundate the system and prevent other critical jobs from obtaining their allocated share of system resources and meeting response goals. Additionally, as the number of workloads running in a system increases, the monitoring of these workloads can adversely increase system overhead, resulting in delays in detecting workloads that have reached their usage limits and allowing workloads to exceed resource allocations. There is a need for a mechanism that can isolate the ever important and critical response time based queries from the system overload, temporarily increase resources to critical requests that are unlikely to meet execution goals, and downgrade running queries or requests that have used more resources than was expected of them.

### BRIEF DESCRIPTION OF THE DRAWINGS

FIG. 1 is a block diagram of a node of a parallel processing database system.

FIG. 2 is a block diagram of a parsing engine.

FIG. 3 is a block diagram of a parser.

FIG. 4 illustrates a simple control group tree.

FIG. 5 illustrates a more complex control group hierarchy.

FIG. 6 illustrates an example of a task group hierarchy defining different priority levels.

FIGS. 7A and 7B provide an illustration of a method for increasing resources to control groups and tasks within a priority level of a task group hierarchy in accordance with a first embodiment of the present invention.

FIGS. 8A and 8B provide an illustration of a method for increasing resources to a control group and tasks within a workload definition in accordance with a second embodiment of the present invention.

FIG. 9 provides a flow diagram illustrating a process for dynamically reallocating database resources among control groups and/or tiers to provide additional database resources to database tasks likely to fail to meet service level goals in accordance with the present invention.

### DETAILED DESCRIPTION OF THE INVENTION

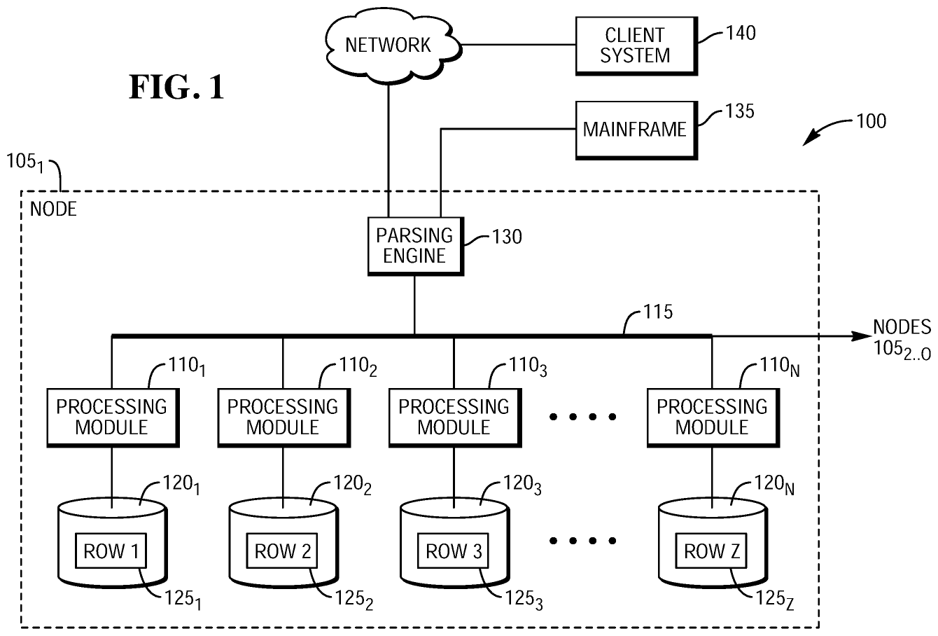

The priority scheduler disclosed herein has particular application, but is not limited, to large databases that may contain many millions or billions of records managed by a database system (“DBMS”) 100 (or “system”), such as a Teradata Database System available from the assignee hereof. FIG. 1 shows a sample architecture for one node 105₁ of the DBMS 100. The DBMS node 105₁ includes one or more processing modules 110_{1 . . . N} (or “CPUs”), connected by a network 115, that manage the storage and retrieval of data in data-storage facilities 120_{1 . . . N}. The DBMS 100 may include multiple nodes 105_{2 . . . N} in addition to the illustrated node 105₁, connected by extending the network 115. In one embodiment, each node may consist of multiple sockets, each of which may have one or more cores. For the purposes of this application, a core will be referred to as a “CPU.” In one embodiment, a “virtual processor” is a collection of processes that run on the same node and share a set of common resources. An AMP, acronym for “Access Module Processor,” is a type of virtual processor used to manage the database. In one embodiment, a node may execute Y virtual processors on top of X CPUs, where Y can be greater than X. In one embodiment, for the purposes of this application, a “process” is a single instance of the execution environment of a single executable file, or program. In one embodiment, a “task” is a single thread of execution within a process. In one embodiment, a “partition” is a construct for grouping tasks together and managing them across multiple virtual processors.

Partitions, which are operating system (“OS”) processes, run in virtual processors. Tasks, which are OS threads, run in partitions.

For the case in which one or more threads are running on a single virtual processor, the single virtual processor swaps among the threads.

For the case in which N threads are running on an M-virtual-processor node, the node's operating system schedules the N threads to run on its set of M virtual processors. The threads are spread among the virtual processors. For example, if there are 4 threads and 4 virtual processors, then typically each thread would run on its own virtual processor. If there are 8 threads and 4 virtual processors, the 8 threads would be spread among the 4 virtual processors, in which case swapping of the threads might occur.

Each of the processing modules 110_{1 . . . N} manages a portion of a database that is stored in a corresponding one of the data-storage facilities 120_{1 . . . N}. Each of the data-storage facilities 120_{1 . . . N} includes one or more disk drives. The system stores data in one or more tables in the data-storage facilities 120_{1 . . . N}. The rows 125_{1 . . . 2} of the tables are stored across multiple data-storage facilities 120_{1 . . . N} to ensure that the system workload is distributed evenly across the processing modules 110_{1 . . . N}. A parsing engine 130 organizes the storage of data and the distribution of table rows 125_{1 . . . Z} among the processing modules 110_{1 . . . N}. The parsing engine 130 also coordinates the retrieval of data from the data-storage facilities 120_{1 . . . N} in response to queries received from a user at a mainframe 135 or a client computer 140. The DBMS 100 usually receives queries and commands to build tables in a standard format, such as SQL.

In one implementation, the rows 125_{1 . . . Z} are distributed across the data-storage facilities 120_{1 . . . N} by the parsing engine 130 in accordance with their primary index. The primary index defines the columns of the rows that are used for calculating a hash value. The function that produces the hash value from the values in the columns specified by the primary index is called the hash function. Some portion, possibly the entirety, of the hash value is designated a “hash bucket”. The hash buckets are assigned to data-storage facilities 120_{1 . . . N} and associated processing modules 110_{1 . . . N} by a hash bucket map. The characteristics of the columns chosen for the primary index determine how evenly the rows are distributed.

In addition to the physical division of storage among the storage facilities illustrated in FIG. 1, each storage facility is also logically organized. One implementation divides the storage facilities into logical blocks of storage space. Other implementations can divide the available storage space into different units of storage. The logical units of storage can ignore or match the physical divisions of the storage facilities.

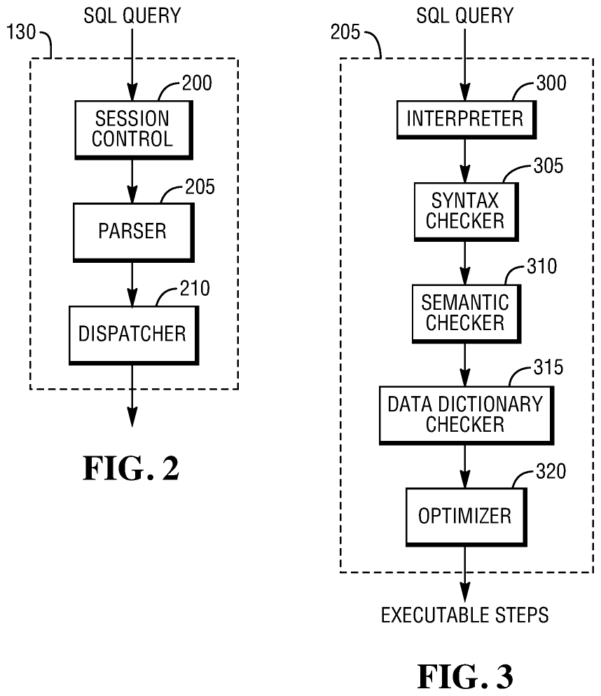

In one example system, the parsing engine 130 is made up of three components: a session control 200, a parser 205, and a dispatcher 210, as shown in FIG. 2. The session control 200 provides the logon and logoff function. It accepts a request for authorization to access the database, verifies it, and then either allows or disallows the access.

Once the session control 200 allows a session to begin, a user may submit a SQL query, which is routed to the parser 205. As illustrated in FIG. 3, the parser 205 interprets the SQL query (block 300), checks it for proper SQL syntax (block 305), evaluates it semantically (block 310), and consults a data dictionary to ensure that all of the objects specified in the SQL query actually exist and that the user has the authority to perform the request (block 315). Finally, the parser 205 runs an optimizer (block 320), which develops the least expensive plan to perform the request and produces executable steps to execute the plan. A dispatcher 210 issues commands to the processing modules 110_{1 . . . N} to implement the executable steps.

### Linux Operating System Scheduler

The scheduler included with the current SUSE Linux Enterprise Server (SLES), referred to as the Completely Fair Scheduler, operates first and foremost on individual tasks and, like earlier schedulers, runs independently on each node in a massively parallel processing (MPP) configuration. One key characteristic of the Linux Completely Fair Scheduler is that it implements priorities using a hierarchy. Viewed as a tree structure, the level that a task is positioned in this tree will influence the share of resources that that the task receives at runtime.

Another key characteristic of the Completely Fair Scheduler that is particularly important to Teradata Database System implementations is that the SLES scheduler can group tasks that have something in common together at the operating system level. In a Teradata Database System, this grouping capability can readily be used to represent all the tasks within one request on a node, or all the tasks executing within one workload on the node.

When task grouping is used, two levels of resource sharing will take place: first at the group level, and then within the group at the task level. Both groups and tasks can co-exist in a priority hierarchy within SLES.

Task grouping is implemented in the SLES scheduler by means of a “control group” mechanism. Control groups allow partitioning and aggregating of tasks that share common characteristics, such as belonging to the same workload or the same request, into hierarchically-placed groups.

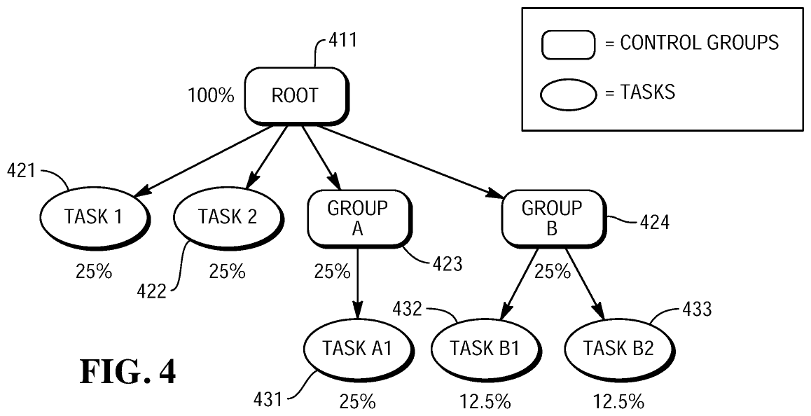

Control groups can give rise to additional control groups below them, which may contain their own hierarchies. FIG. 4 illustrates a simple control group tree.

Each request running on a Teradata Database node will have multiple tasks, for example, one per AMP, that need to be recognized and prioritized as a unit.

Conceptually, resources flow within this Linux tree structure from the top of the control group hierarchy to the bottom, with resources allocated equally among the groups of tasks that fall under a control group. For example, four tasks or task groups, Task 1, Task 2, Group A, and Group B, identified by reference numerals 421, 422, 423, and 424, respectively, are shown one level below Root Group 411, and each receive a resource allocation of 25% of the parent group 401. As Group A 423 contains a single Task, Task A1, identified by reference numeral 431, this task receives the full allocation of Group A, i.e., 25%. Group B contains two tasks, Task B1 and Task B2, identified by reference numerals 432 and 433, respectively, which each receive one half of the resource allocations for Group B, i.e., 12.5%. Such a control group tree provides a blueprint for how resources will flow through the system. The tree represents the plan for how the differently prioritized entities will share resources among them.

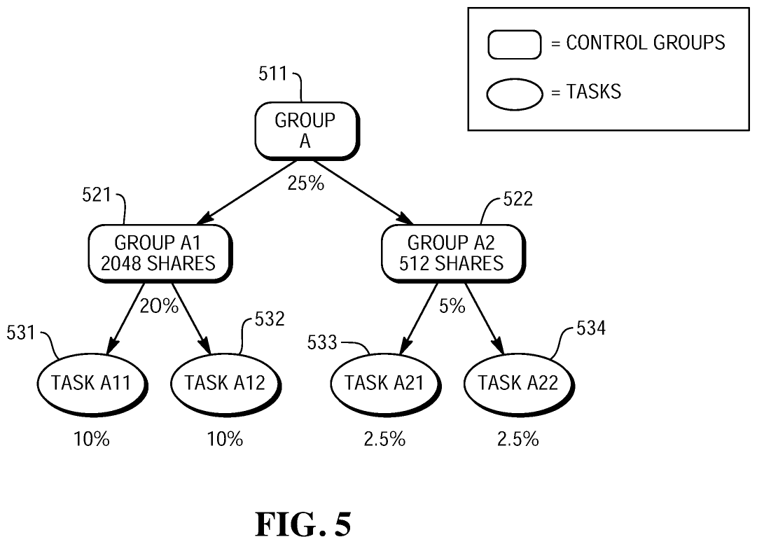

FIG. 5 illustrates a more complex combination of control groups and tasks. In the control group hierarchy shown in FIG. 5, Group A, identified by reference numeral 511 has a total allocation of 2560 “shares” or 25% of resources. In Linux SLES 11, numbers called “shares” determine the portion of resources that will be made available to a control group compared to everything else under that parent at that level. If there is only one control group or task at a given level, it will receive 100% of what flows down to that level from the level above. Shares override the default state of giving all children under a parent an equal share. Shares are a mechanism to represent priority and will be discussed in the next section. Notice that the Control Group A1, identified by reference numeral 521, has been assigned 2048 shares or a 20% allocation of resources, while Control Group A2, identified by reference numeral 522, has been given 512 shares or 5% a 5% allocation of resources.

Within Group A1 (reference number 521), Task A11 (reference number 531) and Task A12 (reference number 532) each receive 10% allocations. Similarly, within Group A2 (reference number 522), Task A21 (reference number 533) and Task A22 (reference number 534) each receive 2.5% allocations. The different allocations to Groups A1, wherein Task A11+Task A12=20% of the resources, and Group A2, wherein Task A21 and Task A22=5% of the resources, is determined from operating system priorities as defined when the tree was constructed.

Shares can be assigned to control groups using basic operating system commands. However, the Teradata Priority Scheduler manages the share assignments for the control groups representing Teradata Database work, based on choices made by the administrator at setup time. High priority workloads will be represented by control groups with a greater number of shares compared to low priority workloads.

Shares are simply numbers that when compared to other similar numbers reflect differences in priority of access to CPU to the operating system. When an administrator, or external program such as Teradata Priority Scheduler, applies a different number of shares to different control groups at the same level in the tree structure, as shown in FIG. 5, then that will influence priority differences for the tasks within those control groups.

In the example above, the administrator assigned 2048 shares to the Control Group A1 (reference number 521) and 512 shares to Control Group A2 (reference number 522), setting up a 4:1 ratio difference in priority for the tasks running in those groups. That leads to the tasks within those two groups receiving a 4:1 ratio in runtime access to resources.

The Completely Fair Scheduler recognizes and supports differences in priority based on:
1. Level in the hierarchy, and
2. The number of assigned shares and their relative value compared to other groups or tasks under the same parent.

At runtime shares are used to determine the weight, or importance, given to a group of tasks, or to an individual task. This weight is used in conjunction with other details to determine which task is the most deserving to receive CPU next. The Linux scheduler makes this decision of what task to run next by means of a different kind of internal tree, called a red-black tree.

Tasks that are waiting for CPU are maintained internally within a red-black tree structure—a self-balancing binary search tree, popular in computing science to organize pieces of comparable data. One advantage of a red-black tree is that it comes with some restrictions on height, making it highly efficient for searches, inserts, deletions, or any changes. Red-black trees are well-suited for making quick operating system decisions in a dynamic environment. There are many red-black tree structures that support the complex decision-making going on inside the operating system, one for each set of parent and children in the hierarchy.

Each local red-black tree has a node for each active task or groups of tasks under a single parent. In addition, there will be one different set of red-black trees for each CPU on the node. Any given task will only be present in one red-black tree structure.

Position in the red-black tree changes quickly because the scheduler is always trying to put the most deserving task or control group into the leftmost position in the tree. Whoever is in the leftmost position runs next on that CPU. If it is a task, the task runs. If the leftmost node in the red-black tree is a control group, the most deserving task underneath that control group will run. The most deserving task is determined based on the local red-black tree that is managing all the tasks under that control group.

These tasks and control groups are sorted within the operating system's red-black tree structures based on their weight (as represented by their operating system shares), as well as how much time they have already spent on the CPU. The entity that combines these two factors (weight and CPU time used), and that controls the position in the red-black tree is known as the virtual runtime of a task.

A virtual runtime is calculated for each control group or each task that is waiting for CPU, based on the weight of a task alongside of the amount of CPU it has already been given.

Virtual runtime of a task or control group is only comparable to the virtual runtime of the other tasks or control groups under the same parent.

Both workloads and the requests under them are control groups. Control groups are components that carry priority and that are assigned shares. Request control groups divide the resources to which their shares entitle them equally among their children (the tasks supporting the request). Tasks do not have an assigned share as do control groups, but equally divide up what is made available to their parent.

In general, virtual runtime for a task is determined by dividing the number of CPU seconds that the task has spent on the CPU already by its portion of the shares that were assigned to the request to which it belongs. If this were part of a Teradata Database request, the number of shares assigned to the request would depend on how its workload priority was established by the administrator.

The contrast in different tasks' virtual runtimes in the red-black tree will influence not only which task will run next, but how long a given task will be allowed to run, once it is given access to CPU. If its virtual runtime is very low compared to the virtual runtimes of other tasks waiting to run, it will be given proportionally more time on the CPU, in an effort to get all virtual runtimes to be equal. This is a fundamental goal of the Linux Completely Fair Scheduler.

The operating system scheduler tries to reach an ideal plateau where no single task is out of balance with what it deserves. Teradata Priority Scheduler provides input based on DBA settings that will be used to determine a task or a control group's weight, based on such things as the workload where the task is running and its level in the control group hierarchy, as well as the share percent the administrator has assigned the workload.

Each CPU tries to service the neediest task first, allowing the tasks with the lowest virtual runtime to execute before others. Virtual runtime accounting is at the nanosecond level, well below a millisecond. Determining what runs next is where the Linux Completely Fair Scheduler name most applies: The Completely Fair Scheduler always tries to split up CPU time between candidate tasks as close to “ideal multi-tasking hardware” as possible. This is truly novel in the history of operating systems and is the key contributing factor in the predictability of the new SLES 11 Priority Scheduler.

### Teradata Priority Scheduler

The Teradata Priority Scheduler utilizes the control group structure inherent in the Linux SLES Completely Fair Scheduler to organize the various priority constructs, with the “workload” being the priority object visible to the operating system. Once the workload is properly defined, the operating system will treat the workload as something it is intimately familiar with—just another control group.

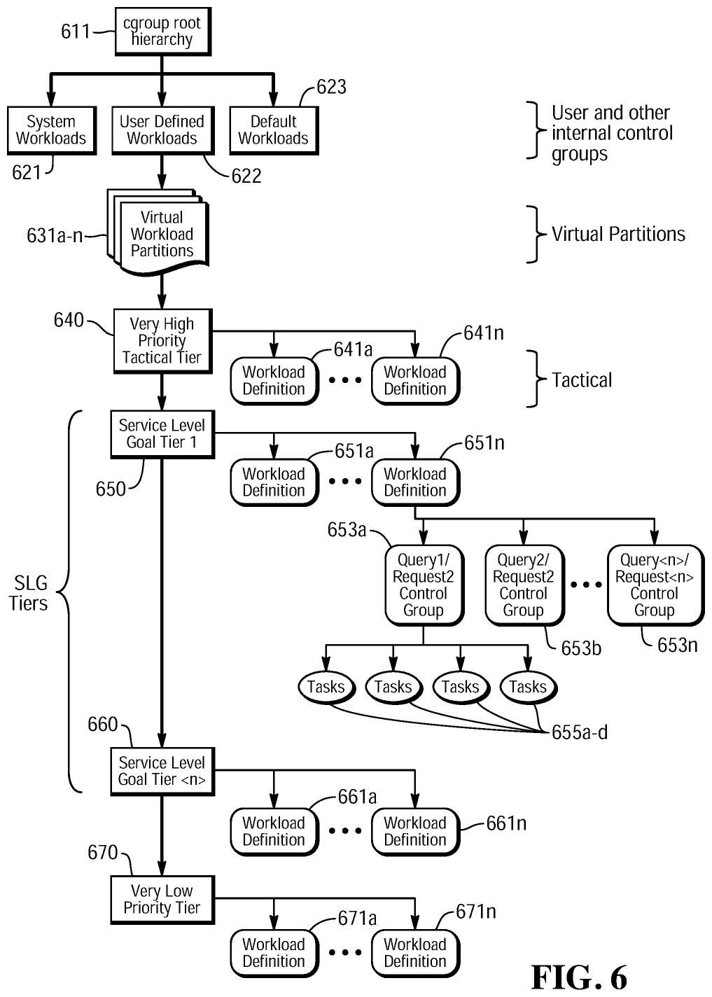

FIG. 6 illustrates an example of how the Priority Scheduler builds on the control group concept to define different priority levels. The tasks that work for a specific user query or request are all grouped under a scheduling entity and laid out in a tree structure. At the highest level, critical internal tasks and activities will execute in the System Workloads control group 621 and Default Workloads control group 623. These groups are expected to use very little resource, allowing all the remaining resources to flow to everything that is underneath the User Defined Workloads control group 622. The User Defined Workloads control group 622 is the starting point for a hierarchy of virtual partitions and workloads that will support Teradata Database work.

Using a tool such as Teradata Corporation Workload Designer, a database administrator (DBA) will indicate where in the tree structure each workload will be located. More important workloads will be assigned higher, in the Tactical 640 and Service Level Goal (SLG) 650-660 Tiers, respectively, and less important workloads will be assigned lower, in the Timeshare level 670. Each defined workload will be instantiated in the hierarchy as a control group.

The positions of the control groups in the hierarchy determines their scheduling priority, with higher tiers having primary access to system resources. Conceptually, resources flow from the top of this tree down through the lower levels. Control groups and their tasks at the higher levels will have their resource needs satisfied before control groups and their tasks at lower levels. Additionally, the nodes in the tree structures can be given tier-based relative weightings by the system administrator to allow even finer control on the available resources on any tier in the tree structure, as well as controlling the unused and left-over resources that flow to the lower tiers after higher tiers have used their allotted share of the system resources. By changing the relative weighting of a control group, more resources can be assigned to a scheduling group at the expense of another control group residing at the same level in the tree. The employment of weightings to workloads can be very helpful when a critical user query/request is competing with other request(s) at the same or lower level.

Virtual partitions, (VPs) 631a-n, shown in FIG. 6, are nodes within the control group hierarchy that sit above and act as a collection point and aggregator for all or a subset of the workloads. A single VP exists for user work by default, but multiple VPs may be defined, if needed. VPs provide the ability to manage resources for groups of workloads dedicated to specific divisions of the business. When a new VP is defined, the administrator will be prompted to define a percentage of the Teradata Database resources that will be targeted for each, from the Viewpoint Workload Designer screens. This percent represents the percent of resources that will be allocated to that VP from what flows down through the User control group.

Once defined, each of these VPs can contain their own control group hierarchies. Each VP hierarchy can include all allowable priority levels from Tactical to Timeshare, as shown in FIG. 6.

Workloads 641a-641n that specify a workload management method of “tactical” are in the first level 640 the under the VPs. The tactical level is intended for workloads that represent highly tuned, very short, requests that have to finish as quickly as possible, even at the expense of other work in the system. An example of a tactical workload is one that is composed of single-AMP or very short few-step all-AMP queries. Workloads identified by the administrator as tactical will receive the highest priority available to user work and will be allowed to consume whatever level of CPU within their VP that they require.

Workloads on the Tactical level will have several special benefits: Tactical workloads are automatically run with an expedited status, which will give queries running in the workload access to special pools of reserved AMP worker tasks if such reserves are defined, and provides them with other internal performance boosts. In addition, tasks running in a tactical workload are able to more easily preempt the CPU from other tasks running in the same or in a different VP, due to their higher operating system weight.

If tactical requests are so resource-intensive that they are able to consume almost all the platform resources, then very little resource will fall to the lower levels. It is recommended that workloads only be placed on the Tactical level if they are very slight consumers of resource, such as single-AMP requests, as the architecture of the new Priority Scheduler is built around the concept that the majority of resources will fall through from Tactical to the levels below.

There may be one to many levels in the hierarchy between the Tactical and Timeshare levels. These Service Level Goal (SLG) Tier levels 650-660 are intended for workloads associated with a service level goal, e.g., a desired response time, throughput, or other performance goal established by the user; or other complex tactical or non-tactical work whose response time is critical to the business. It may be that only a single SLG Tier will be adequate to satisfy this non-tactical, yet time-dependent work. Each SLG Tier includes control groups and tasks organized within one or more Workload Definitions, such as Workload Definitions 651a-651n within SLG Tier 1 (650) and Workload Definitions 661a-661n within SLG Tier n (660); each Workload Definition includes one or more Control Groups, such as control groups 653a-653n within Workload Definition 651n; and each control group may engage one or more Tasks, such as Tasks 655a-655d within Control Group 653a. The lowest priority level, Timeshare level 670, including Workload Definitions 671a-671n, is structured similarly to the Tactical and SLG Tier levels.

If more than one SLG Tier is assigned workloads, the higher tiers will have their workload requirements met more fully than workloads on the lower tiers. Workloads in Tier 1 will always be serviced ahead of workloads in Tier 2; Tier 2 will be serviced before Tier 3, and so forth.

Resources not used at a tier will automatically be provided to lower tiers. Resources flow downward to the next tier either because they are not able to be used by workloads on the current tier or have been set aside for the tiers below.

Each SLG Tier can support multiple workloads. A workload allocation is specified by the DBA when a workload is assigned to a particular SLG Tier. The workload allocation represents the percent of the resources that the administrator would like to target to that particular workload from within the resources that are made available to that tier. In other words, the workload allocation is a percent of that tier's available resources, not a percent of system resources, and not a percent of VP resources.

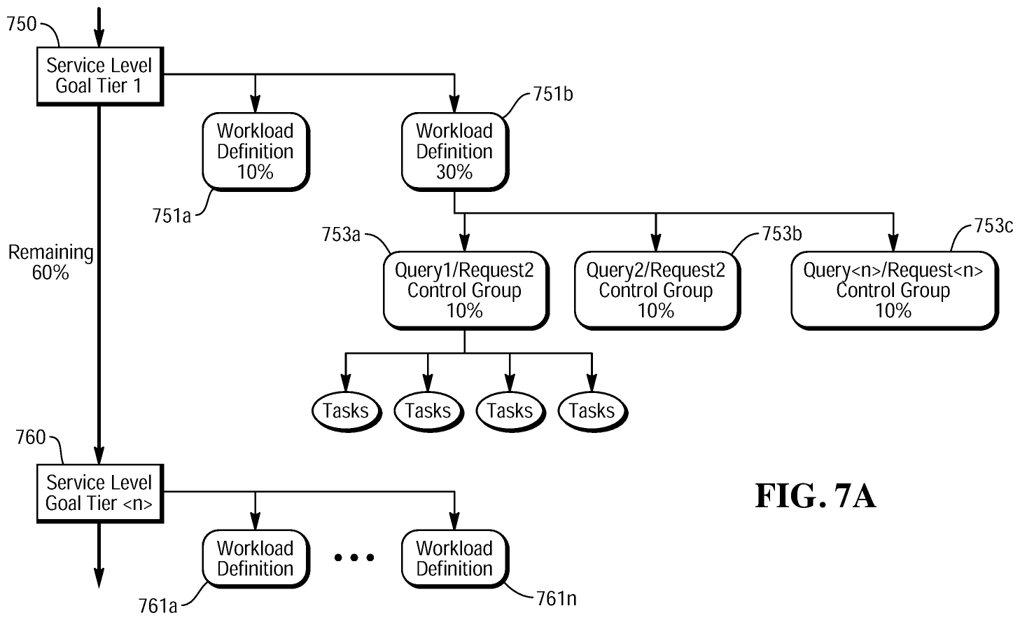

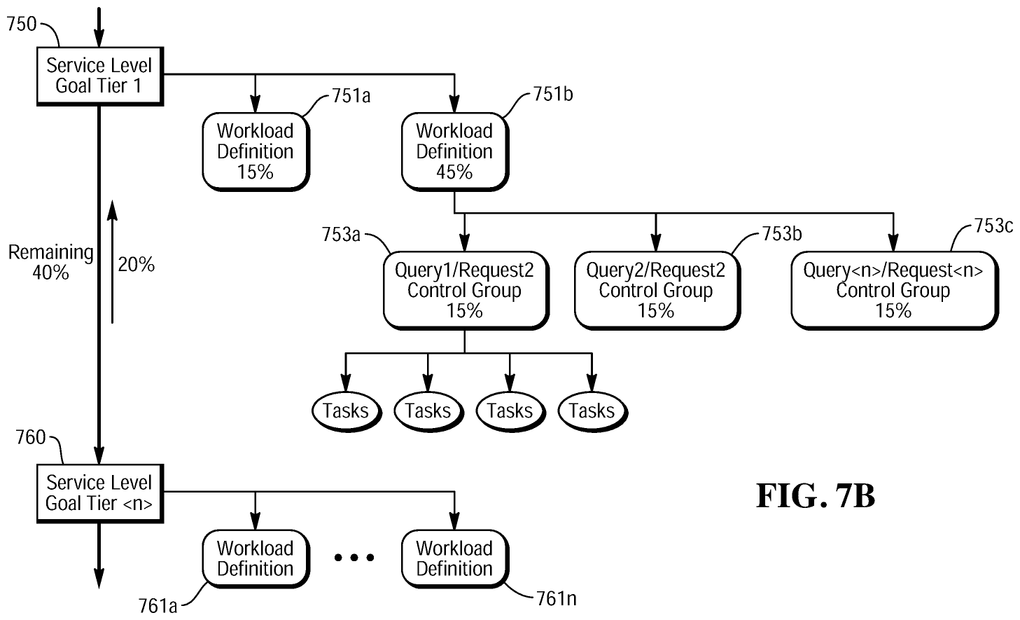

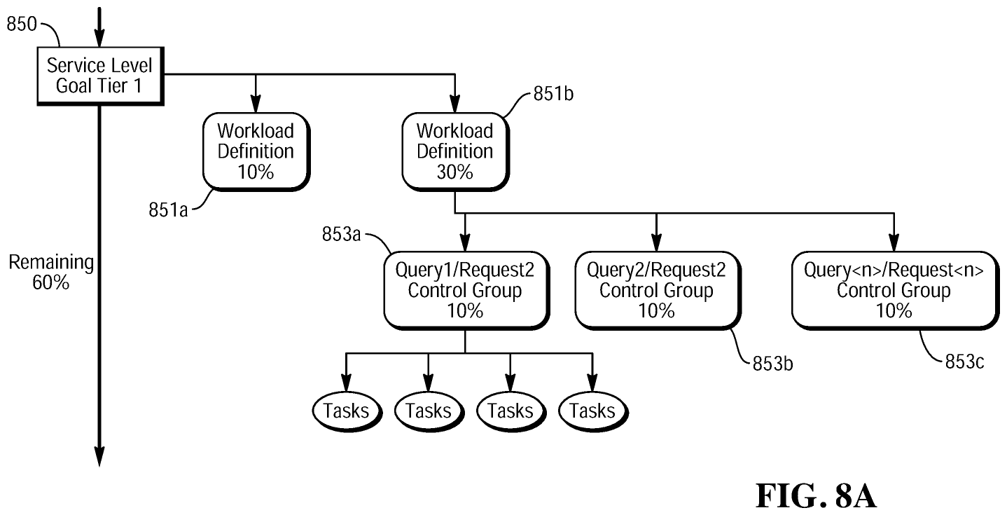

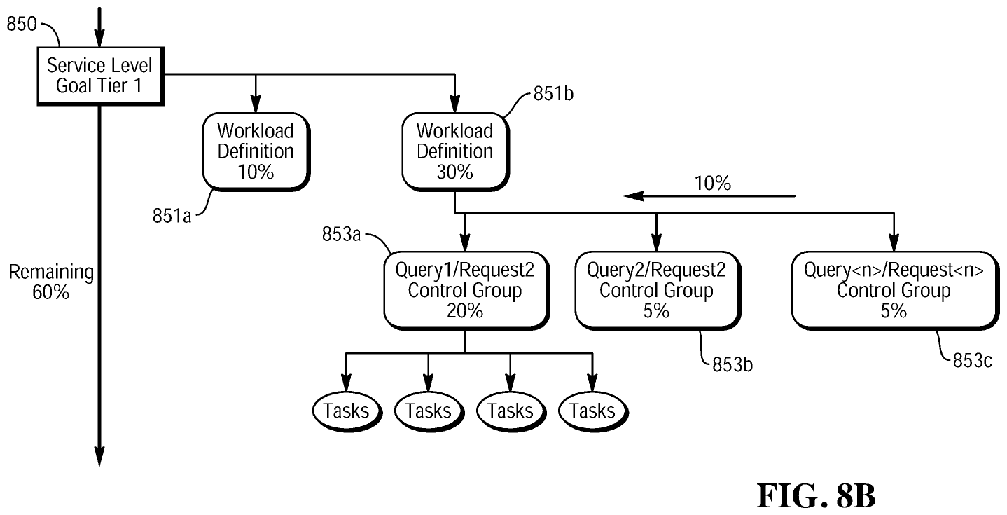

Each workload in an SLG Tier will carry a workload allocation, also known as a workload share percent, which represents the percent of the resources intended for the workload among the resources that flow into the SLG tier. FIGS. 7A and 8A, discussed below, illustrate this allocation, within SLG Tier 1.

Additional details concerning priority scheduling techniques employed within Teradata Corporation database systems, including the allocation of database resources among control groups and tasks are provided in U.S. Pat. No. 9,298,506, entitled “ASSIGNING RESOURCES AMONG MULTIPLE TASK GROUPS IN A DATABASE SYSTEM,” by Sorana Rabinovici and Venu Gopal Joshi, issued on Mar. 29, 2016; and U.S. Pat. No. 8,612,989, entitled “ASSIGNING RESOURCES AMONG MULTIPLE GROUPS OF WORKLOADS IN A DATABASE SYSTEM,” by Anita Richards and Douglas P. Brown, issued on Dec. 17, 2013; which are incorporated by reference herein.

### Dynamic Boosting Mechanism

As described above, the position of a control group in the priority hierarchy determines the scheduling priority of the control group, with control groups in higher tiers getting primary access to system resources. Additionally, the nodes in the tree structures can be given tier based relative weighting by a system administrator to allow finer control of the available resources on any tier in the tree structure, as well as controlling the unused resources that flow to lower tiers after the top tiers have used their allotted share of the system resources. By changing the relative weighting of a control group, more resources can be assigned to a scheduling group at the expense of another control group residing at the same level in the tree. This can be very helpful when a critical user query/request is competing with other requests at the same or lower level.

The mechanism described and illustrated herein provides for the dynamic modification of the weighting of a Query/Request control group failing to meet its service level goal to obtain additional resources away from other Query/Request control groups under the same workload definition. Alternatively, the mechanism will allow the system to dynamically change the weighting at the lagging Query/Request control group's tier level to appropriate additional resources that would otherwise flow downward to lower tier levels. When a boosted request has sufficiently improved its progress toward achieving its SLG, the weighting can be reset back to original settings, allowing other requests to reclaim the resources taken to speed up the lagging request.

FIGS. 7A and 7B provide an illustration of the process for boosting at a control group's tier level. Referring to FIG. 7A, default system resource allocations for components within Service Level Goal Tier 1, identified by reference numeral 750, are shown. In this simple example illustration, SLG Tier 750 includes two workload definitions, 751a and 751b, and workload definition 751b is shown to include three query/request control groups 753a, 753b, and 753c. The default resource allocations for workload definitions 751a and 751b are shown to be 10% and 30%, respectively, of resources made available to SLG Tier 750 from higher in the task group hierarchy illustrated more fully in FIG. 6. Within workgroup definition 751b, each of query/request control groups have been allocated 10% of system resources flowing to SLG Tier 750. The 60% of system resources not allocated to SLG Tier 750 components are made available to lower tiers within the task group hierarchy.

FIG. 7B provides an illustration of SLG Tier 750 component resource allocations following execution of tier level boosting to provide additional resources to one or more of the SLG tier level components. Referring to FIG. 7B, 20% of the system resources formerly passed down from SLG Tier 750 are retained by SLG Tier 750 and distributed to components within the tier level. During this temporary reallocation workload definitions 851a and 851b are shown to be allocated 15% and 45%, respectively, of resources made available to SLG Tier 750, and each of query/request control groups are assigned 15% of system resources flowing to SLG Tier 750. 40% of system resources of system resources flowing to SLG Tier 750 are made available to lower tiers within the task group hierarchy.

FIGS. 8A and 8B provide an illustration of the process for boosting at a control group's peer level. Referring to FIG. 8A, default system resource allocations for components within Service Level Goal Tier 1, now identified by reference numeral 850, are again shown. Similar to FIG. 7A, SLG Tier 850 includes two workload definitions, 851a and 851b, with workload definition 851b shown to include three query/request control groups 853a, 853b, and 8753c. The default resource allocations for workload definitions 851a and 851b are shown to be 10% and 30%, respectively, of resources made available to SLG Tier 850 from higher in the task group hierarchy. Within workgroup definition 851b, each of query/request control groups have been allocated 10% of system resources flowing to SLG Tier 750. The 60% of system resources not allocated to SLG Tier 850 components are made available to lower tiers within the task group hierarchy.

FIG. 8B provides an illustration of SLG Tier 850 component resource allocations following execution of peer level boosting to provide additional resources to query/request control group 853a. Referring to FIG. 8B, 5% of the system resources formerly allocated to each of query/request control groups 853b and 853c are temporarily reallocated to query/request control group 853a. During this temporary reallocation the resources allocated to query/request control group 853a is seen to be increased to 20%, while the system resource allocations to each of query/request control groups 853b and 853c has been reduced to 5%. The allocations to workload definitions 851a and 851b remain at 10% and 30%, respectively, of resources made available to SLG Tier 850, and 60% of system resources of system resources flowing to SLG Tier 850 continue to be made available to lower tiers within the task group hierarchy.

Control group based operating systems provide an interface to adjust component weighting across the hierarchy. This interface can be used to enable boosting for a Query/Request control group that is on the verge of failing to meet its service level goal.

The interface definition for the boosting mechanism provides the database optimizer engine means to provide the boosting factor at each step level within a request. This boosting factor can be at the Workload Definition sibling level, at the Service Level Goal (SLG) Tier level, or at both. As priority values are always passed at the step levels, the boosting factors can be passed along with the priority values or workload definition values.

Sample pseudo code for the interface is provided below:

#define SLG_TIER_SHIFT 28
#define SLG_SIBLING_SHIFT 24
#define WORKLOAD_DEFINITION_MASK 0xFF000000
#define BOOST_MASK(TierFactor, SiblingFactor)

(WORKLOAD_DEFINITION_MASK & \

| | |
|---|---|
| (TierFactor << SLG_TIER_SHIFT) \| | \ |

(SiblingFactor << SLG_SIBLING_SHIFT)))

RequestContextBlock.CurrentStepLevel.WorkloadDefinition =
NextWorkloadDefinition | BOOST_MASK(TierFactor,
SiblingFactor)

This interface would allow the database optimizer engine to obtain additional information about the boost multiplier to be applied at the sibling or the tier level.

Meanwhile the Priority Scheduler module would extract this information and increase the relative shares of the scheduler control groups.

Boolean SLGApplyBoost(RequestContextBlock)
{
...
TierControlGroup.Shares =

(RequestContextBlock.CurrentStepLevel.WorkloadDefinition

& WORKLOAD_DEFINITION_MASK)

>> SLG_TIER_SHIFT ) * controlgroup_default_shares

SiblingControlGroup.Shares =

((RequestContextBlock.CurrentStepLevel.WorkloadDefinition

& WORKLOAD_DEFINITION_MASK)

>> SLG_SIBLING_SHIFT ) * controlgroup_default_shares

...
controlgroup_set_shares(TierControlGroup);
controlgroup_set_shares(SiblingControlGroup);
...
}

The controlgroup_set_shares would apply the shares provided to the scheduler entities so that they can get the appropriate resources relative to the entities at the same level.

As can be seen from the interface description and algorithm above, by providing a multiplying factor, the tier and sibling control groups can have a higher value of shares relative to their peers at the same level.

The same interface can be used to reset the shares to default when the boosting is no longer needed by merely providing a boosting multiplier of 1. For cases where the application of shares is an expensive operation involving a greater operating system scheduler overhead, this interface can be modified to apply the shares only if they have been changed from the previous application.

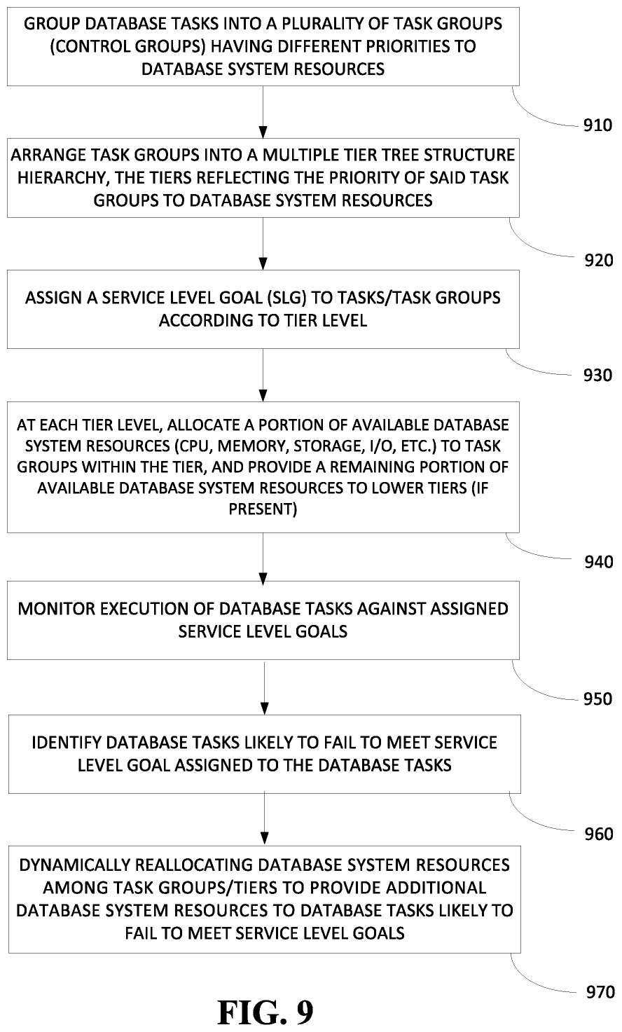

The process for establishing control groups, assigning weightings, and dynamically reallocating database resources among control groups and/or tiers to provide additional database resources to database tasks likely to fail to meet service level goals is further illustrated in the flow diagram of FIG. 9.

Referring to the flow diagram of FIG. 9, database tasks can be grouped into a plurality of task groups (control groups) having different priorities to database system resources (step 910), and task groups arranged into a multiple tier tree structure hierarchy, the tiers reflecting the priority of said task groups to database system resources (step 920), with service level goals (SLGs) assigned to tasks/task groups according to tier level (step 930).

Using the interface discussed above, a portion of available database system resources (CPU, memory, storage, I/O, etc.) are assigned to task groups within each tier (step 940). At each tier level above the lowest level, a remaining portion of available database system resources not assigned to the task groups within the tier is provided to lower tiers.

During execution of database tasks, the progress of the executed tasks is monitored against the service level goals associated with the tasks (step 950). The process identifies database tasks that are likely to fail to meet their associated service level goal (step 960), and database resources are dynamically reallocated among tiers as illustrated in FIGS. 7A and 7B, or among task groups as shown in FIGS. 8A and 8B, to provide additional database system resources to the database tasks likely to fail to meet service level goals (step 970). Database resource allocations are returned to original allocations once tasks have been completed or progress against service level goals improves.

The foregoing describes, and the accompanying figures illustrate, a database system priority scheduler which organizes database threads into task groups within a specific hierarchy, assigns database system resources to task groups according to the hierarchy, and dynamically reallocates resources to critical requests that are unlikely to meet execution goals. Through the temporary boosting of a lagging request's priority, by providing the request with additional compute and I/O resources to be used by remaining processing steps, request/task performance against expected service level goal is improved.

The foregoing description of the preferred embodiments of the invention has been presented for the purposes of illustration and description. It is not intended to be exhaustive or to limit the invention to the precise form disclosed. Many modifications and variations are possible in light of the above teaching. For example, the priority scheduler described above can be implemented within on-premises, cloud-based, or hybrid cloud database systems. It is intended that the scope of the invention be limited not by this detailed description, but rather by the claims appended hereto.

What is claimed is:

1. A computer-implemented method for scheduling and executing a plurality of database tasks within a database system, the method comprising the steps of:
grouping said database tasks into a plurality of task groups within a hierarchy;
assigning database system resources to said task groups according to the positions of said task groups within said hierarchy;
assigning service level goals to said task groups;
monitoring execution of said database tasks against said service level goals assigned to said task groups;
identifying one of said database tasks within one of said task groups as failing to meet the service level goal assigned to said one of said database task groups; and
dynamically allocating additional database system resources to said one of said task groups.

2. The computer-implemented method for scheduling and executing a plurality of database tasks within a database system according to claim 1, wherein said step of dynamically allocating additional database system resources to said one of said task groups comprises reallocating database system resources among said task groups located within an equivalent position in said hierarchy as said one of said task groups to allocate additional database system resources to said one of said task groups.

3. The computer-implemented method for scheduling and executing a plurality of database tasks within a database system according to claim 1, wherein said step for dynamically allocating additional database system resources to said one of said task groups comprises reallocating database system resources from task groups at a lower position in said hierarchy than the position of said one of said task groups to allocate additional database system resources to said one of said task groups.

4. The computer-implemented method for scheduling and executing a plurality of database tasks within a database system according to claim 1, further comprising the steps of:
monitoring execution of said one of said database tasks against the service level goal assigned to said one of said task groups; and
removing the allocation of additional database system resources to said one of said task groups when said one of said database tasks is projected to meet the service level goal assigned to said one of said task groups.

5. The computer-implemented method for scheduling and executing a plurality of database tasks within a database system according to claim 1, wherein said database system resources include at least one of:
computer processor resources,
computer memory resources,
computer data storage resources, and
input/output resources.

6. A computer-implemented method for scheduling and executing a plurality of database tasks within a database system, the method comprising the steps of:
assigning database system resources to said database tasks;
assigning service level goals to said database tasks;
monitoring execution of said database tasks against said service level goals assigned to said database tasks;
identifying one of said database tasks as projected to fail to meet the service level goal assigned to said one of said database tasks; and
dynamically allocating additional database system resources to said one of said database tasks.

7. The computer-implemented method for scheduling and executing a plurality of database tasks within a database system according to claim 6, wherein said step of dynamically allocating additional database system resources to said one of said database tasks comprises reallocating database system resources among said database tasks to allocate additional database system resources to said one of said database tasks.

8. The computer-implemented method for scheduling and executing a plurality of database tasks within a database system according to claim 6, further comprising the steps of:
monitoring execution of said one of said database tasks against the service level goal assigned to said one of said database tasks; and
removing the allocation of additional database system resources to said one of said database tasks when one of said database tasks is projected to meet the service level goal assigned to said one of said database tasks.

9. The computer-implemented method for scheduling and executing a plurality of database tasks within a database system according to claim 6, wherein said database system resources include at least one of:
computer processor resources,
computer memory resources,
computer data storage resources, and
input/output resources.

10. A computer-implemented method for scheduling the execution of a plurality of database tasks within a database system, the method comprising the steps of:
grouping said database tasks into a plurality of task groups having different priorities to database system resources;
arranging said task groups into a hierarchy, said hierarchy comprising multiple tiers including a top level tier, a bottom level tier and at least one intermediate level tier between said top level tier and said bottom level tier, said tiers reflecting the priority of said task groups to said database system resources, and each of said tiers have a service level goal assigned to task groups contained within the tier;
allocating a portion of said database system resources to said task groups within said top level tier, and providing a remaining portion of said database system resources not assigned to said task groups within said top level to the tier immediately below said top level tier;
for each intermediate level tier: receiving the remaining portion of database system resources not assigned to the task groups in the tier immediately above; assigning a portion of said database system resources received from the tier immediately above to said task groups within said each immediate level tier, and providing a remaining portion of said database system resources not assigned to said task groups within said each immediate tier to the tier immediately below said each immediate level tier;
executing said database tasks in accordance with said database resource task group allocations.
monitoring execution of said database tasks against said service level goals assigned to said tiers;
identifying one of said database tasks within one of said task groups as failing to meet the service level goal assigned to said one of said task groups; and
dynamically allocating additional database system resources to said one of said task groups.

11. The computer-implemented method for scheduling and executing a plurality of database tasks within a database system according to claim 10, wherein said step of dynamically allocating additional database system resources to said one of said task groups comprises reallocating database system resources among said task groups located within the tier including said one of said task groups to allocate additional database system resources to said one of said task groups.

12. The computer-implemented method for scheduling and executing a plurality of database tasks within a database system according to claim 10, wherein said step of dynamically allocating additional database system resources to said one of said task groups comprises reallocating database system resources from task groups at a lower tier in said hierarchy than said one of said task groups to allocate additional database system resources to said one of said task groups.

13. The computer-implemented method for scheduling and executing a plurality of database tasks within a database system according to claim 10, further comprising the steps of:
monitoring execution of said one of said database tasks against the service level goal assigned to said one of said task groups; and
removing the allocation of additional database system resources to said one of said task groups when said one of said database tasks is projected to meet the service level goal assigned to said one of said task groups.

14. The computer-implemented method for scheduling and executing a plurality of database tasks within a database system according to claim 10, wherein said database system resources include at least one of:
computer processor resources,
computer memory resources,
computer data storage resources, and
input/output resources.

15. A database system, running on a computer, the database system comprising:
at least one computer processor having access to at least one data storage device containing a database;
a process executed by said at least one computer processor to schedule the execution of a plurality of database tasks within said database system, said process comprising the steps of:
grouping said database tasks into a plurality of task groups within a hierarchy;
assigning database system resources to said task groups according to the positions of said task groups within said hierarchy;
assigning service level goals to said task groups;
monitoring execution of said database tasks against said service level goals assigned to said task groups;
identifying one of said database tasks within one of said task groups as failing to meet the service level goal assigned to said one of said database task groups; and
dynamically allocating additional database system resources to said one of said task groups.

16. The database system in accordance with claim 15, wherein said process step of dynamically allocate additional database system resources to said one of said task groups comprises reallocating database system resources among said task groups located within an equivalent position in said hierarchy as said one of said task groups to allocate additional database system resources to said one of said task groups.

17. The database system in accordance with claim 15, wherein said process step of dynamically allocating additional database system resources to said one of said task groups comprises reallocating database system resources from task groups at a lower position in said hierarchy than the position of said one of said task groups to allocate additional database system resources to said one of said task groups.

18. The database system in accordance with claim 15, wherein said process further comprises the steps of:
monitoring execution of said one of said database tasks against the service level goal assigned to said one of said task groups; and
removing the allocation of additional database system resources to said one of said task groups when said one of said database tasks is projected to meet the service level goal assigned to said one of said task groups.

19. The database system in accordance with claim 15, wherein said database system resources include at least one of:
computer processor resources,
computer memory resources,
computer data storage resources, and
input/output resources.

20. A database system, running on a computer, the database system comprising:
at least one computer processor having access to at least one data storage device containing a database;
a process executed by said at least one computer processor to schedule the execution of a plurality of database tasks within said database system, said process comprising the steps of:
assigning database system resources to said database tasks;
assigning service level goals to said database tasks;
monitoring execution of said database tasks against said service level goals assigned to said database tasks;
identifying one of said database tasks as projected to fail to meet the service level goal assigned to said one of said database tasks; and
dynamically allocating additional database system resources to said one of said database tasks.

21. The database system in accordance with claim 20, wherein said process step of dynamically allocating additional database system resources to said one of said database tasks comprises reallocating database system resources among said database tasks to allocate additional database system resources to said one of said database tasks.

22. The database system in accordance with claim 20, said process further comprising the steps of:
monitoring execution of said one of said database tasks against the service level goal assigned to said one of said database tasks; and
removing the allocation of additional database system resources to said one of said database tasks when one of said database tasks is projected to meet the service level goal assigned to said one of said database tasks.

23. The database system in accordance with claim 20, wherein said database system resources include at least one of:
computer processor resources,
computer memory resources,
computer data storage resources, and
input/output resources.

24. A non-transitory computer-readable medium having a computer program for scheduling and executing a plurality of database tasks within a database system, the computer program including executable instructions that cause a computer to:
group said database tasks into a plurality of task groups within a hierarchy;
assign database system resources to said task groups according to the positions of said task groups within said hierarchy;
assign service level goals to said task groups;
monitor execution of said database tasks against said service level goals assigned to said task groups;
identify one of said database tasks within one of said task groups as failing to meet the service level goal assigned to said one of said database task groups; and
dynamically allocate additional database system resources to said one of said task groups.

25. The non-transitory computer-readable medium having a computer program for scheduling and executing a plurality of database tasks within a database system in accordance with claim 24, wherein said executable instruction to dynamically allocate additional database system resources to said one of said task groups includes an instruction to reallocate database system resources among said task groups located within an equivalent position in said hierarchy as said one of said task groups to allocate additional database system resources to said one of said task groups.

26. The non-transitory computer-readable medium having a computer program for scheduling and executing a plurality of database tasks within a database system in accordance with claim 24, wherein said executable instruction to dynamically allocate additional database system resources to said one of said task groups includes an instruction to reallocate database system resources from task groups at a lower position in said hierarchy than the position of said one of said task groups to allocate additional database system resources to said one of said task groups.

27. The non-transitory computer-readable medium having a computer program for scheduling and executing a plurality of database tasks within a database system in accordance with claim 24, said computer program further including executable instructions that cause said computer to:
monitor execution of said one of said database tasks against the service level goal assigned to said one of said task groups; and
remove the allocation of additional database system resources to said one of said task groups when said one of said database tasks is projected to meet the service level goal assigned to said one of said task groups.

28. The non-transitory computer-readable medium having a computer program for scheduling and executing a plurality of database tasks within a database system in accordance with claim 24, wherein said database system resources include at least one of:
computer processor resources,
computer memory resources,
computer data storage resources, and
input/output resources.

29. A non-transitory computer-readable medium having a computer program for scheduling and executing a plurality of database tasks within a database system, the computer program including executable instructions that cause a computer to:
assign database system resources to said database tasks;
assign service level goals to said database tasks;
monitor execution of said database tasks against said service level goals assigned to said database tasks;
identify one of said database tasks as projected to fail to meet the service level goal assigned to said one of said database tasks; and
dynamically allocate additional database system resources to said one of said database tasks.

30. The non-transitory computer-readable medium having a computer program for scheduling and executing a plurality of database tasks within a database system in accordance with claim 29, wherein said executable instruction to dynamically allocate additional database system resources to said one of said database tasks includes an instruction to reallocate database system resources among said database tasks to allocate additional database system resources to said one of said database tasks.

31. The non-transitory computer-readable medium having a computer program for scheduling and executing a plurality of database tasks within a database system in accordance with claim 29, said computer program further including executable instructions that cause said computer to:
monitoring execution of said one of said database tasks against the service level goal assigned to said one of said database tasks; and
removing the allocation of additional database system resources to said one of said database tasks when one of said database tasks is projected to meet the service level goal assigned to said one of said database tasks.

32. The non-transitory computer-readable medium having a computer program for scheduling and executing a plurality of database tasks within a database system in accordance with claim 29, wherein said database system resources include at least one of:
computer processor resources,
computer memory resources,
computer data storage resources, and
input/output resources.
